(19) United States
(12) Patent Application Publication
(10) Pub. No.: US 2008/0076305 A1
(43) Pub. Date: Mar. 27, 2008

(54) Connector base structures for a connector

(75) Inventor: Tai-Sheng Wang, Jhonghe City (TW)

Correspondence Address: Troxell Law Office Pllc, Suite 1404, 5205 Leesburg Pike, Falls Church, VA, 22041, US

(73) Assignee: Alltop Technology Co., Ltd.

(21) Appl. No.: 11/526,074

(22) Filed: Sep. 25, 2006

(51) Int. Cl. H01R 13/62

(52) U.S. Cl. 439/725

(57) ABSTRACT

The present invention provides connector base structures for a connector, wherein a connector is structured from at least a first connector base and a second connector base. Abutting of protrusions of the first connector base and guide clasps of the second connector base enables achieving effectiveness to correctly guide and completely join terminals thereof, and effectively prevent erroneous connection therebetween. Furthermore, clasping of hook portions and clasp holes facilitates joining the first connector base and the second connector base, thereby achieving the objective of effecting a firm clasp between the first connector base and the second connector base and preventing them from coming apart.

### BACKGROUND OF THE INVENTION

(a) Field of the Invention

Art of the present invention provides connector base structures for a connector, and mote particularly to a connector able to prevent connector bases from coming apart.

(b) Description of the Prior Art

When connector bases of a composite connector of prior art are mutually joined, the connector bases are connectively joined by clasping together insertedly fitted terminals on the respective connector bases, but lacks a structural configuration able to prevent the connector bases from coming apart, and thus easily results in the connector bases slipping and coming apart when using the connector, thereby causing poor contact between the terminals of the connector bases.

Furthermore, prior art connectors lack a configuration that provides for preventing an erroneous connection between the connector bases, and thus easily results in an erroneous electrical connection between the connector bases when using the connector.

Hence, the inventor of the present invention proposes to resolve and surmount existent technical difficulties to eliminate the aforementioned shortcomings of prior art.

### SUMMARY OF THE INVENTION

Art of the present invention provides connector base structures for a connector, and mote particularly to a connector able to prevent connector bases from coming apart, and which further has effectiveness to correctly align connector bases and prevent erroneous connection therebetween.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an exploded view according to the present invention.

FIG. 2 shows a first view of an embodiment according to the present invention.

FIG. 3 shows a second view of an embodiment according to the present invention.

FIG. 4 shows a third view of an embodiment according to the present invention.

FIG. 5 shows a fourth view of an embodiment according to the present invention.

### DETAILED DESCRIPTION OF THE PREFERRED EMBODIMENTS

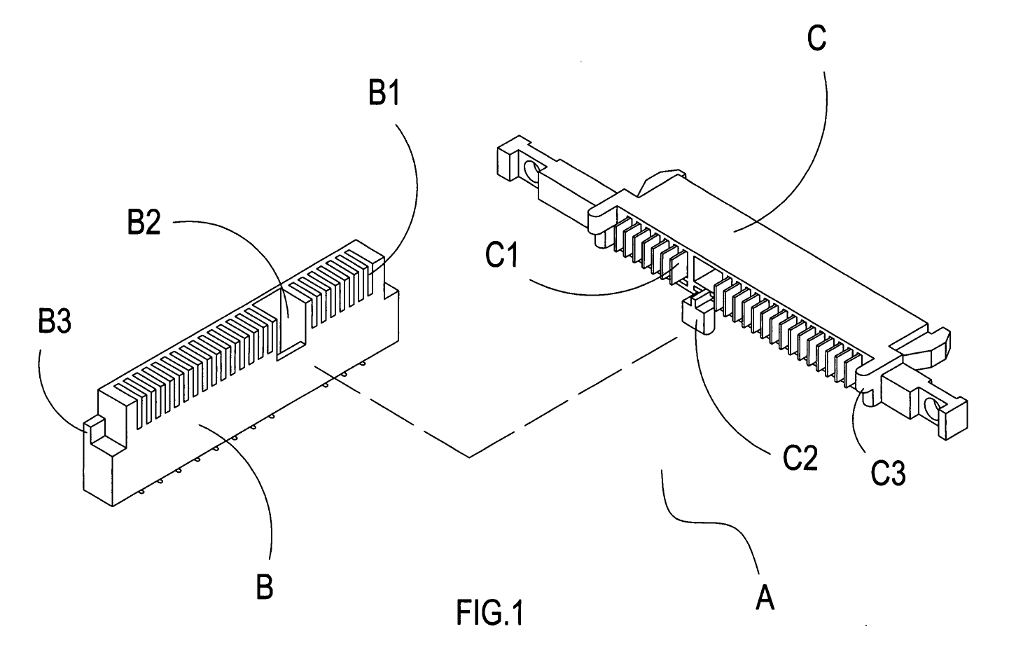

The present invention provides connector base structures for a connector, as depicted in FIG. 1, wherein a connector A is structured to comprise at least a first connector base B and a second connector base C. A plurality of mutually corresponding terminals B1, C1 are disposed between the first connector base B and the second connector base C respectively, and a clasp hole B2 is defined at one side of the first connector base B, thereby enabling a corresponding hook portion C2 located on the second connector base C to clasp therewith. A protrusion B3 and a corresponding guide clasp C3 are located on two side ends of the first connector base B and the second connector base C respectively, which enable mutual abutting of the first connector base B and the second connector base C.

The coordinating clasp between the clasp hole B2 and the hook portion C2 enables the first connector base B to be firmly joined to the second connector base C, thereby achieving the objective of effecting a firm clasp between the first connector base B and the second connector base C and preventing them from coming apart. Moreover, mutual abutting between the protrusion B3 and the guide clasp C3 enables joining of the first connector base B to the second connector base C, thereby achieving effectiveness to correctly align the first connector base B to the second connector base C and prevent erroneous connection therebetween.

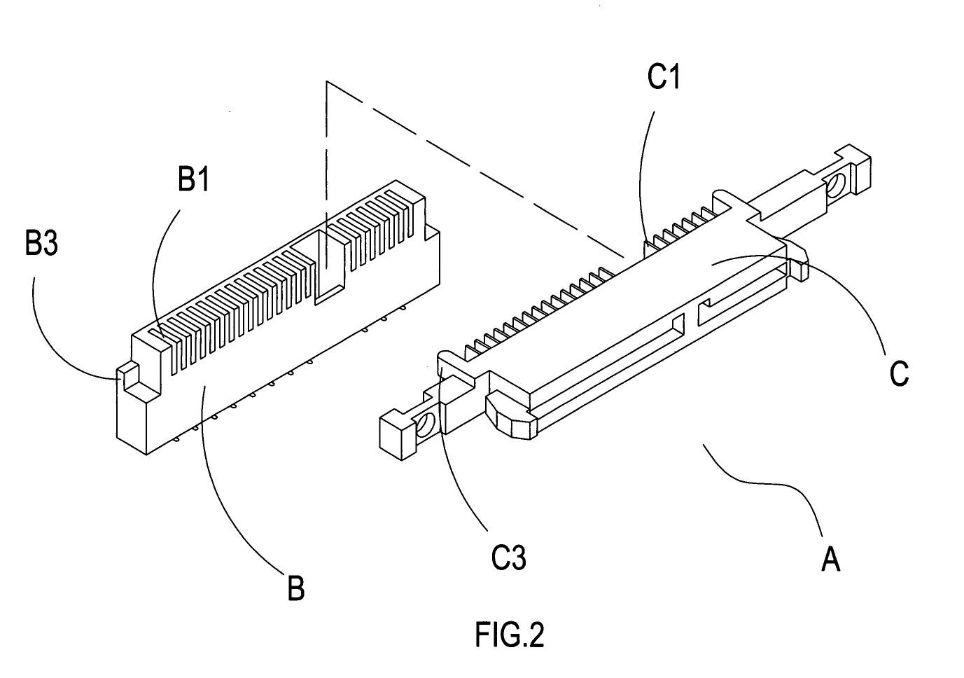

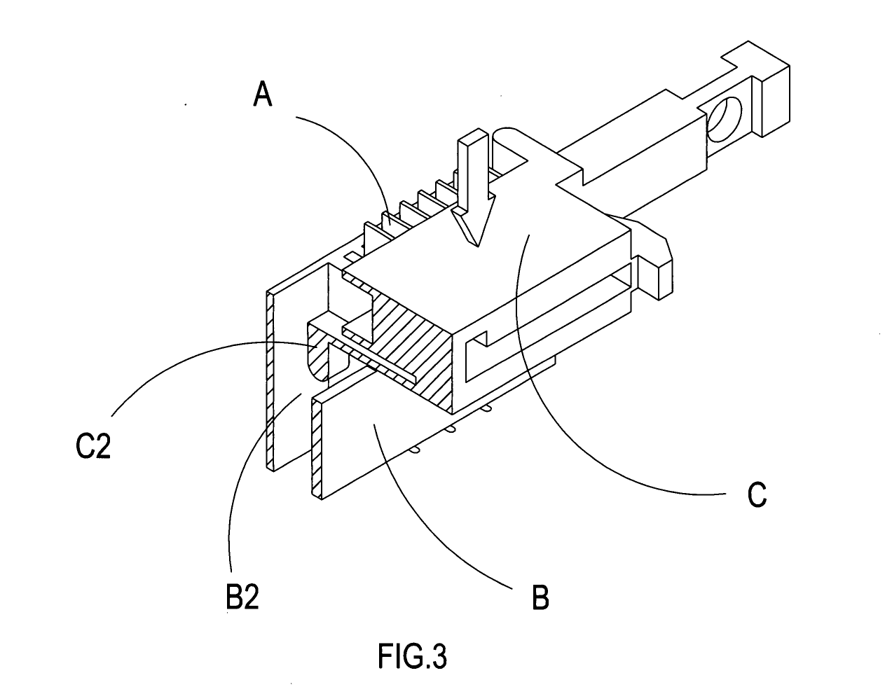

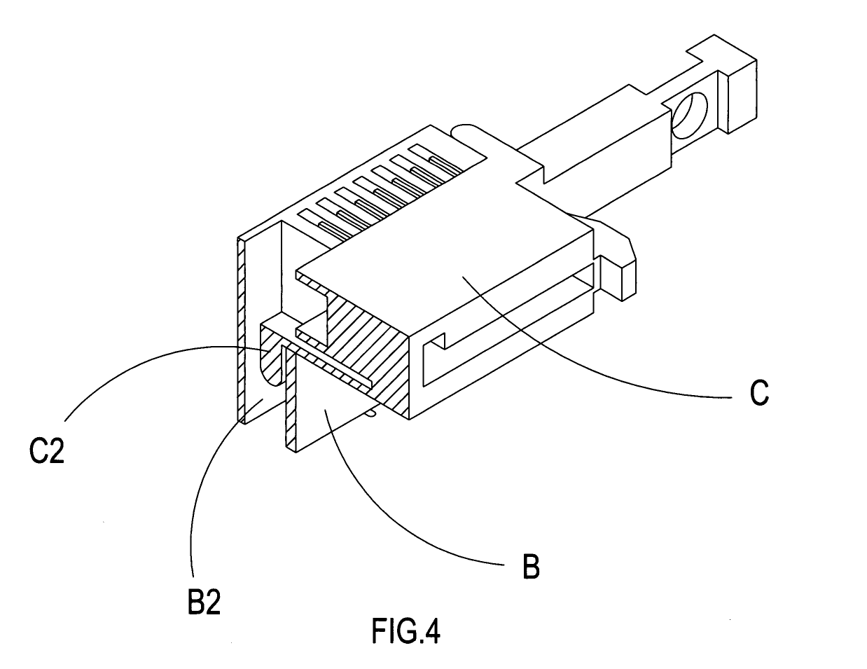

An embodiment of the present invention provides connector base structures for a connector, as depicted in FIGS. 2, 3 and 4, wherein a first connector base B and a second connector base C of a connector A are joined together. A guide clasp C3 of the second connector base C abuts with a protrusion B3 located on the first connector base B to enable correct alignment of the first connector base B and the second connector base C, at which time a hook portion C2 located on the second connector base C hooks into a clasp hole B2 of the first connector base B, thereby achieving the objective of preventing the first connector base B and the second connector base C from coming apart.

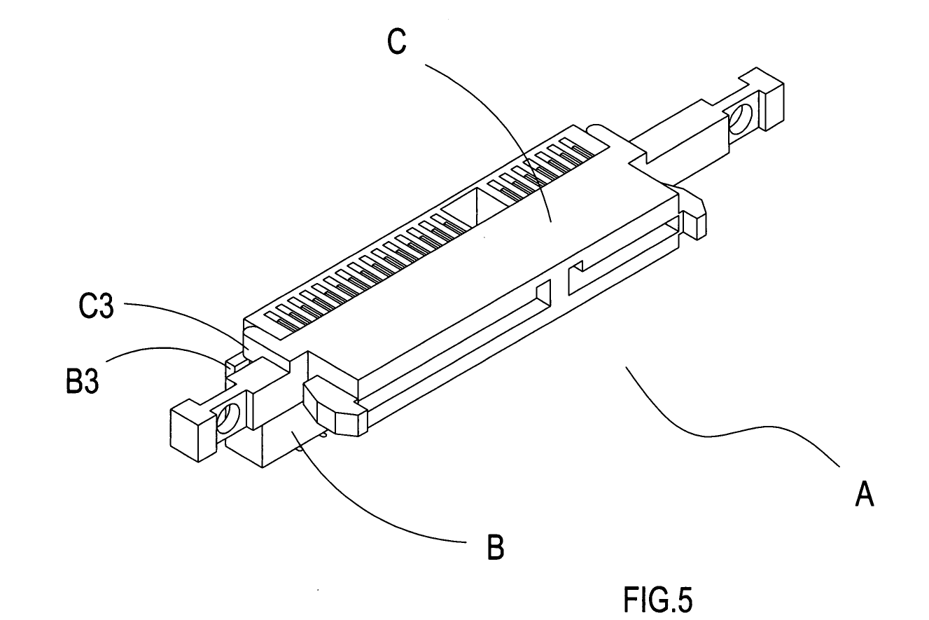

Referring to FIG. 5, wherein the first connector base B and the second connector C of the connector A have been erroneously connected, and the protrusion B3 of the first connector base B and the guide clasp C3 of the second connector base C have formed a low top state, thereby preventing the terminals B1 of the first connector base B (see FIG. 2) from effecting a connection with terminals C1 of the second connector base C, which and thus effectively prevents an erroneous connection between the first connector base B and the second connector base C from occurring.

In order to better explicitly disclose advancement and practicability of the present invention, a comparison with prior art is described hereinafter:

Shortcomings of Prior Art

1. Easily results in occurrence the connector bases slipping and coming apart.

2. Easily results in erroneous connection between the connector bases.

### ADVANTAGES OF THE PRESENT INVENTION

1. Joining of the connector bases B, C enables achieving a firm clasp therebetween and prevents the connector bases B, C from coming apart.

2. The protrusion B3 and the guide clasp C3 effectively achieve the objective of correctly aligning the connector bases B, C and preventing erroneous connection therebetween.

3. Increases functional efficiency of the connector A.

4. Provided with advancement and practicability.

5. Enhances industrial competitiveness.

In conclusion, the present invention in overcoming structural shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

1. Connector base structures for a connector, comprising:
a first connector base having a plurality of insertedly fitted aligned terminals and a clasp hole located between a first group of the insertedly fitted aligned terminals and a second group of the insertedly fitted aligned terminals; and
a second connector base having a plurality of insertedly fitted aligned terminals and a hook portion having a protruding head at one end located in a position corresponding to the clasp hole;
whereby when a matching connection is effected between the first connector base and the second connector base, the hook portion clasps and joins to the clasp hole through the insertion of the protruding head into the clasp hole, thereby realizing a connection between the first connector base and the second connector base, achieving objective of preventing the first connector base and the second connector from coming apart and effecting a firm clasp therebetween.

2. The connector base structures for a connector according to claim 1, wherein the coordinating connection between the first connector base and the second connector base is realized by insertedly connecting the plurality of aligned terminals of the first connector base with the plurality of aligned terminals of the second connector base.

3. The connector base structures for a connector according to claim 1, wherein protrusions are symmetrically located on two side ends of the first connector base, and guide clasps are symmetrically located on two side ends of the second connector base.

4. The connector base structures for a connector according to claim 3, wherein abutting of the protrusions and the guide clasps enables achieving effectiveness to correctly guide and prevent erroneous connection between the first connector base and the second connector base.
